(19) United States
(12) Patent Application Publication
(10) Pub. No.: US 2017/0172368 A1
(43) Pub. Date: Jun. 22, 2017

(54) Remote Home Security Monitoring System And Method Thereof

(71) Applicants: Inventec (Pudong) Technology Corporation, Shanghai (CN); Inventec (Beijing) Electronics Technology Co., Ltd, Beijing (CN)

(72) Inventor: Chaucer Chiu, Taipei (TW)

(21) Appl. No.: 15/073,456

(22) Filed: Mar. 17, 2016

(30) Foreign Application Priority Data
Dec. 17, 2015 (CN) 201510954112.5

(51) Int. Cl. A47L 11/40; G08B 25/10; G05D 1/00; G08B 21/14

(52) U.S. Cl. CPC A47L 11/4011; G08B 21/14; G08B 25/10; G05D 1/0022; G05D 2201/0203; A47L 2201/04

(57) ABSTRACT

A remote home security monitoring system and a method thereof are disclosed. In the system, an air sensor, a temperature sensor, a sound sensor and a charge-coupled device are integrated in a cleaning robot and configured to continuously sense air quality, ambient temperature and ambient sound when the cleaning robot is turned on, so as to generate ambient data which is further analyzed to determine an ambient state. When the ambient state is determined to be dangerous, the cleaning robot stops cleaning and notifies a remote user instantly, and provides the user to enable and control the charge-coupled device and a sound collection element to continuously record environment audio/video, and store the environment audio/video in a remote storage device. Therefore, the present disclosure can help to improve the comprehensiveness of home security monitoring.

### CROSS-REFERENCE TO RELATED APPLICATION

This application claims the benefit of Chinese Patent Application No. 201510954112.5, filed Dec. 17, 2015.

### BACKGROUND OF THE INVENTION

Field of the Invention

The present disclosure relates to a monitoring system and a method thereof, more particularly to a remote home security monitoring system capable of instantly notifying a user when an ambient state is determined to be dangerous and providing the user to perform remote control to generate and receive environment audio/video, and a method thereof.

Description of the Related Art

Generally speaking, a conventional cleaning robot (also called as a robot cleaner) can automatically clean floor, such as sweeping, absorbing dust, mopping, washing and so on, and further automatically moves back to a base for charging while power is insufficient. However, gradually the user does not satisfy with the conventional cleaning robot just having the single cleaning function, and it becomes a main problem of the conventional cleaning robot to be solved.

There is a manufacturer providing a cleaning robot with the monitoring technology. A CCD and a human body sensing unit are integrated in such cleaning robot to detect an intruder, record audio and video data about the intruder, and then transmit the audio and video data to security guards. However, such cleaning robot merely detects the intruder, so the comprehensiveness of protection for home security is still not enough. The problem of insufficient comprehensiveness of home security monitoring is still not solved effectively.

In conclusion, the conventional technology problem of only monitoring the intruder and not having enough comprehensiveness in home security monitoring, has existed for a long time, and what is need is to provide an improved technology manner to solve this problem.

### SUMMARY OF THE INVENTION

An objective of the present disclosure is to provide a remote home security monitoring system and a method thereof.

According to one exemplary embodiment of the present disclosure, a remote home security monitoring system is applied in a cleaning robot and includes a sensing module, an analysis module, a notifying module and a remote control module. The sensing module is configured to continuously sense a set of ambient data by using an air sensor, a temperature sensor and a sound sensor integrated in the cleaning robot when the cleaning robot is turned on. The analysis module is configured to analyze the set of ambient data to generate an ambient state based on a default set of security data, and then determine the ambient state to be dangerous when a difference between the set of the ambient data and the set of the security data exceeds a tolerable range. The notifying module is configured to stop the cleaning robot cleaning, transmit a notice message to a user end and initialize network to provide the user end to link with the cleaning robot when the ambient state is determined to be dangerous. The remote control module is configured to provide the user end to remotely control a charge-coupled device and a sound collection element integrated on the cleaning robot after the user end is linked with the cleaning robot, so as to generate and receive environment audio/video.

According to one exemplary embodiment of the present disclosure, a remote home security monitoring method is applied in a cleaning robot and includes following steps: using an air sensor, a temperature sensor and a sound sensor integrated in the cleaning robot to continuously sense a set of ambient data when the cleaning robot is turned on; analyzing the set of the ambient data based on default security data to generate an ambient state, and determining the ambient state to be dangerous when a difference between the set of ambient data and the default security data exceeds a tolerable range; stopping the cleaning robot cleaning when the ambient state is determined to be dangerous, and transmitting a notice message to a user end and initializing network to provide the user end to link with the cleaning robot; providing the user end to remotely control a charge-coupled device and a sound collection element integrated in the cleaning robot to generate and receive environment audio/video after the user end is linked with the cleaning robot.

In conclusion, the difference between the system and method of the present disclosure and the conventional technology is that in the system and method of the present disclosure the air sensor, the temperature sensor, the sound sensor and the CCD are integrated in the cleaning robot to continuously sense the air quality, the ambient temperature and the ambient sound when the cleaning robot is turned on, to generate the ambient data which is then analyzed to determine the ambient state, and when the ambient state is determined to be dangerous, the cleaning robot is stopped cleaning and instantly notifies the remote user (at the user end), and provides the remote user to enable and control the CCD and the sound collection element to continuously record the environment audio/video and store the environment audio/video to the remote storage device.

By means of the technology of the present disclosure, the technical effect of improving the comprehensiveness of home security monitoring can be achieved.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a block diagram of a remote home security monitoring system of the present disclosure.

FIG. 2 is a flow chart of a remote home security monitoring method of the present disclosure.

FIG. 3 is a schematic view of applying the home security monitoring, in accordance with the present disclosure.

FIG. 4 is a schematic view of applying the charge-coupled device and the sound collection element of the present disclosure.

### DETAILED DESCRIPTION

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

Before the illustration of the remote home security monitoring system and the method thereof disclosure in the present disclosure, the environment where the technology of the present disclosure is applied is illustrated first. The technology of the present disclosure is applied on a cleaning robot which can automatically navigate to clean the floor, for example, sweep, absorb dust, mop, and wash the floor, and move back to a base for charging. The cleaning robot applied in the present disclosure is provided with multiple sensors (such as an air sensor, a temperature sensor and a sound sensor) for sensing the ambient data, and a charge-coupled device and a sound collection element which can be remotely controlled by a user end to generate environment audio/video, and the user end can then receive the environment audio/video.

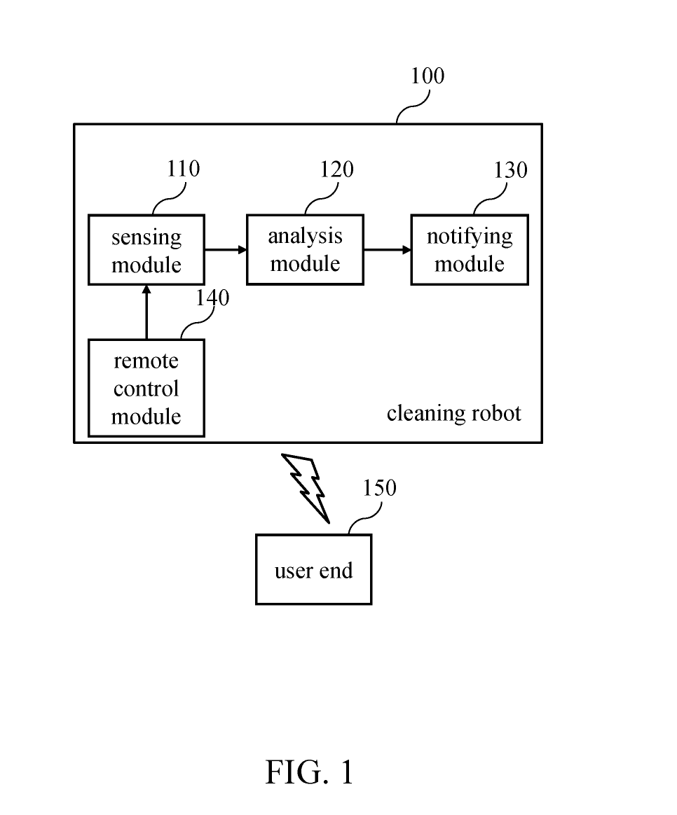

Reference will now be made in detail to the exemplary embodiments of the remote home security monitoring system and method of the present disclosure, examples of which are illustrated in the accompanying drawings. Please refer to FIG. 1 which is a block diagram of the remote home security monitoring system of the present disclosure. The system is applied in a cleaning robot 100 and includes a sensing module 110, an analysis module 120, a notifying module 130 and a remote control module 140. The sensing module 110 is configured to continuously sense a set of ambient data through an air sensor, a temperature sensor and a sound sensor integrated on the cleaning robot 100 when the cleaning robot 100 is turned on. In practice, the air sensor can sense concentrations of carbon monoxide, fine particulate matter and gas. The manners of sensing carbon monoxide, fine particulate matter and gas are conventional technologies, so their detailed descriptions are omitted.

The analysis module 120 is configured to analyze the ambient data based on default security data, to generate an ambient state. When the difference between the ambient data and the default security data is greater than a tolerable range, the analysis module 120 determines the ambient state to be dangerous. In practice, each of the default security data and the ambient data includes data of carbon monoxide, fine particulate matter, gas, ambient temperature and ambient sound, but the former is the data of default safe range and the latter is the sensed current ambient data. Therefore, the default security data can be compared with the ambient data for analysis, and the ambient state is set as dangerous when the difference between the ambient data and the default security data is greater than the preset tolerable range. For example, under a condition that the security data includes 50 ppm, 60 μg/m3 and 3000 ppm, and the preset tolerable range is +0.1%, the analysis module 120 sets the ambient state to be dangerous when the difference between the ambient data and the default security data is greater than +0.1% (that is, the ambient data exceeds the security data by 0.1%). It should be noted that the security data and the tolerable range can be preconfigured and pre-stored in the cleaning robot 100 to facilitate the analysis and determination of the analysis module 120.

The notifying module 130 is configured to stop the cleaning robot 100 cleaning and transmit a notice message to a user end 150 when the ambient state is set as dangerous, and initialize network to provide the user end 150 to link with the cleaning robot 100. The notice message can be transmitted to the user end 150 by at least one of email, instant communication, or SMS (Short Message Service). The cleaning robot 100 may cause disaster (such as gas explosion) if keeping the cleaning operation under the dangerous ambient state, so the notifying module 130 stops the cleaning robot 100 cleaning first and then transmits the notice message to the user end 150, so as to remind the user that the ambient state where the cleaning robot 100 is operated is determined to be dangerous. Next, the notifying module 130 starts to initialize network, for example, the notifying module 130 can enable network port, network protocol and so on, so that the user end 150 can be linked with the cleaning robot 100.

After the user end 150 is linked with the cleaning robot 100, the remote control module 140 provides the user end 150 to remotely control a CCD and a sound collection element integrated in the cleaning robot 100, to generate and receive environment audio/video. In practice, the remote control module 140 can further simultaneously transmit the environment audio/video to a remote storage device, such as a network attached storage (NAS), for storing.

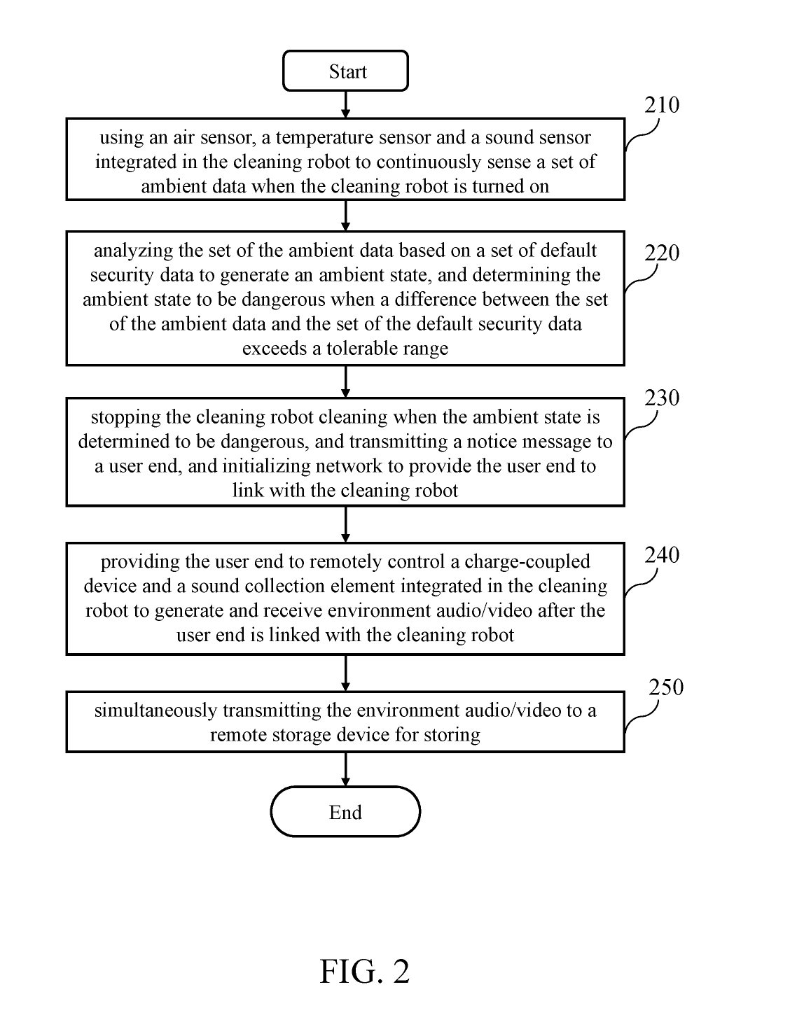

Please refer to FIG. 2 which is a flow chart of a remote home security monitoring method of the present disclosure. The method includes following steps. After the cleaning robot 100 is turned on, the air sensor, the temperature sensor and the sound sensor integrated in the cleaning robot 100 are used to continuously sense a set of the ambient data (step 210). The ambient data is analyzed based on the preset security data, to generate the ambient state, and the ambient state is determined to be dangerous if the difference between the ambient data and the security data is larger than the tolerable range (step 220). Under the condition that the ambient state is determined to be dangerous, the cleaning robot 100 is stopped cleaning and the notice message is transmitted to the user end 150, and the network is initialized to provide the user end 150 to link with the cleaning robot 100 (step 230). After the cleaning robot 100 is linked with the user end 150, the user end 150 can remotely control the CCD and the sound collection element integrated in the cleaning robot 100, to generate and receive the environment audio/video (step 240). Through aforesaid steps, the air sensor, the temperature sensor, the sound sensor and the CCD integrated in the cleaning robot 100 can be used to continuously sense the air quality, the ambient temperature and the ambient sound when the cleaning robot 100 is turned on, so as to generate the ambient data which is then analyzed to determine the ambient state, and the cleaning robot 100 is stopped cleaning and the remote user (at the user end 150) is notified instantly when the ambient state is determined to be dangerous, the remote user can enable and control the CCD and the sound collection element to continuously record the environment audio/video and store the environment audio/video in the remote storage device.

In addition, after step 240, the environment audio/video can be simultaneously transmitted and stored to the remote storage device (step 250). Consequently, even if the cleaning robot 100 is broken or damaged, the user still can obtain the recorded environment audio/video from the remote storage device.

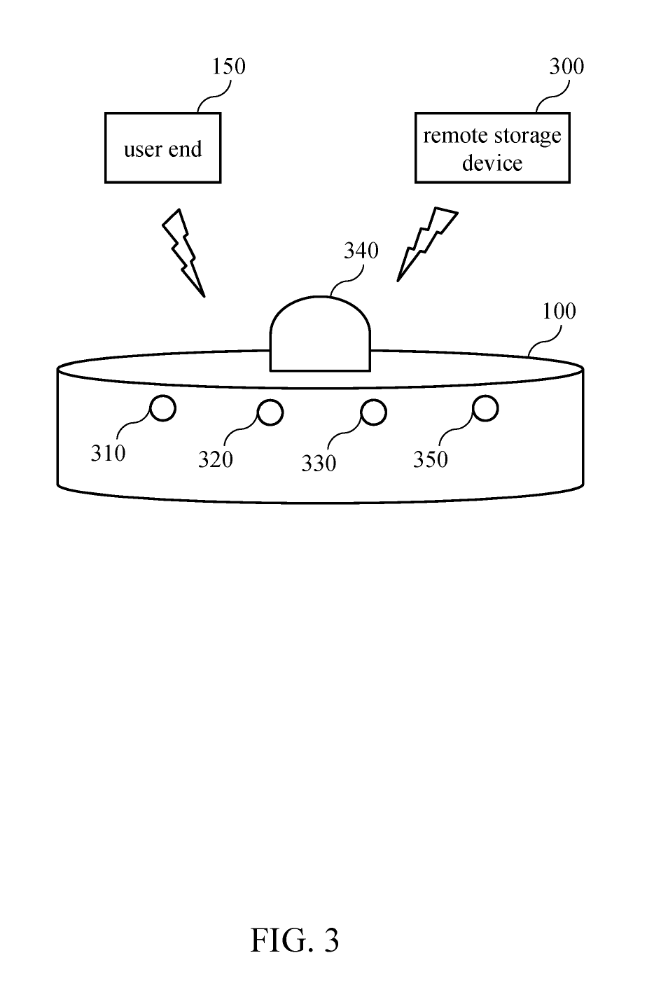

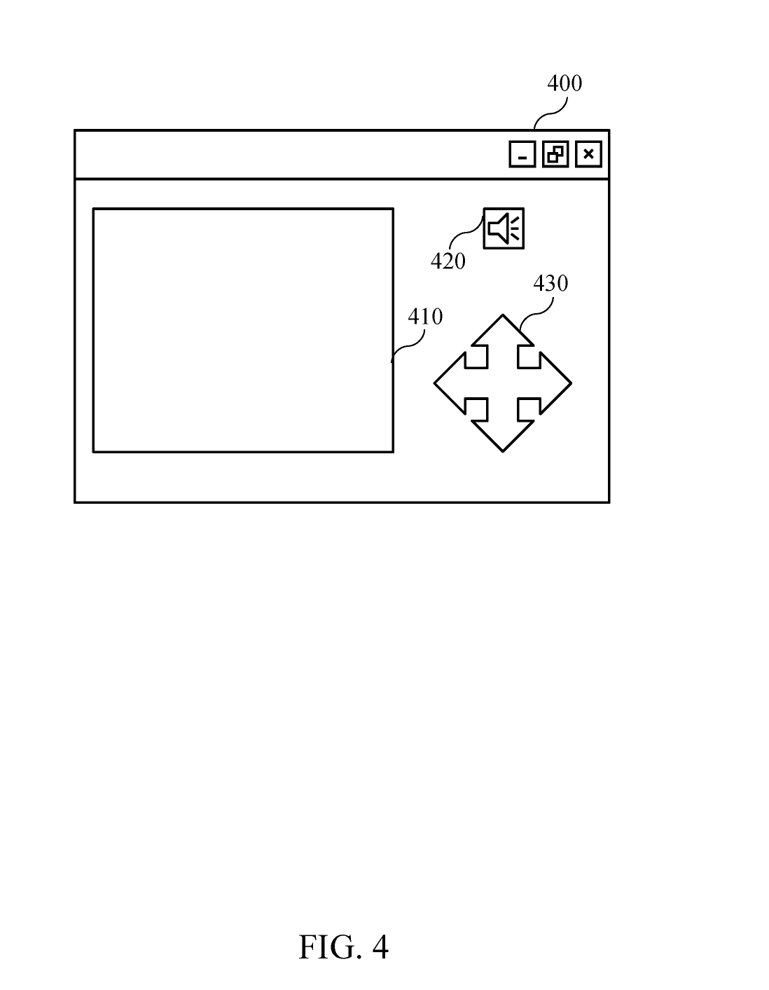

The following paragraphs describe embodiments in cooperation with FIGS. 3 and 4 for illustrating the present disclosure. Please refer to FIG. 3 which is a schematic view of applying the technology of the present disclosure to monitor home security. In practice, before going to work, the user can turn on the cleaning robot 100 to clean floor and, in the meantime, the air sensor 310, the temperature sensor 320 and the sound sensor 330 integrated in the cleaning robot 100 are also started to continuously sense the set of the ambient data which is then compared with the default security data to determine the ambient state. For example, when the one of concentrations of carbon monoxide, fine particulate matter and gas becomes abnormal, or the ambient temperature is far higher than a normal temperature, or the sensed sound is abnormal, the ambient state is determined to be dangerous. Various abnormal concentrations may damage human body, the temperature far higher than the normal temperature may occur fire, and abnormal sound possibly indicates that there is an intruder, so the ambient state is set as dangerous, and the notice message is then transmitted to the user end 150 and the network is initialized to enable the user at the user end 150 to remotely control the charge-coupled device 340 and the sound collection element 350 (such as microphone) to obtain instant home environment audio/video. Therefore, the user can start corresponding action based on the environment audio/video, for example, the user can call the police, firemen, ambulance and so on. In addition, in consideration that the cleaning robot 100 may be broken or damaged, the environment audio/video can be simultaneously transmitted to the remote storage device 300 for remote backup, and the environment audio/video can be reference data for law enforcement agencies or ambulance units in future.

Please refer to FIG. 4 which is a schematic view of remotely controlling the charge-coupled device and the sound collection element of the present disclosure. As shown in FIG. 4, the user end 150 can remotely control the charge-coupled device 340 and the sound collection element 350 integrated in the cleaning robot 100, to generate and receive the environment audio/video. In practice, the user end 150 can provide a remote control window 400 for the user to operate the remote control. For example, the environment audio/video generated by the charge-coupled device 340 can be instantly displayed on the display area 410 for user's browse, and the user can adjust a capturing angle of the charge-coupled device 340 by operating direction keys 430. In addition, the user can click a sound reception key 420 to control sound recording, such as adjustment of volume of received sound, mute, and so on. Therefore, when the cleaning robot 100 determines the ambient state to be dangerous, the user can remotely control the charge-coupled device 340 and the sound collection element 350 to obtain the instant environment audio/video for check the environment condition.

In conclusion, the difference between the system and method of the present disclosure and the conventional technology is that the in the system and method of the present disclosure the air sensor, the temperature sensor, the sound sensor and the CCD are integrated in the cleaning robot to continuously sense the air quality, the ambient temperature and the ambient sound when the cleaning robot is turned on, so as to generate the ambient data which is then analyzed to determine the ambient state, and when the ambient state is determined to be dangerous, the cleaning robot is stopped cleaning and instantly notify the remote user, and provide the remote user to enable and control the CCD and the sound collection element to continuously record the environment audio/video and store the environment audio/video in the remote storage device. By means of the technology of the present disclosure, the conventional technology problem can be solved, so as to achieve the technical effect of improving the comprehensiveness of the home security monitoring.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

1. A remote home security monitoring system, applied in a cleaning robot, the remote home security monitoring system comprising:
a sensing module configured to continuously sense a set of ambient data by using an air sensor, a temperature sensor and a sound sensor integrated in the cleaning robot, when the cleaning robot is turned on;
an analysis module configured to analyze the set of ambient data based on a set of default security data, to generate an ambient state, and determine the ambient state to be dangerous when a difference between the set of the ambient data and the set of the default security data exceeds a tolerable range;
a notifying module configured to stop the cleaning robot cleaning, transmit a notice message to a user end and initialize network to provide the user end to link with the cleaning robot when the ambient state is determined to be dangerous; and
a remote control module configured to provide the user end to remotely control a charge-coupled device and a sound collection element integrated in the cleaning robot after the cleaning robot is linked with the user end, so as to generate and receive environment audio/video.

2. The remote home security monitoring system according to claim 1, wherein the air sensor is configured to sense concentrations of carbon monoxide, fine particulate matter and gas.

3. The remote home security monitoring system according to claim 1, wherein the set of the default security data comprises safe ranges of carbon monoxide, fine particulate matter, gas, ambient temperature and ambient sound.

4. The remote home security monitoring system according to claim 1, wherein the notice message is transmitted to the user end through at least one of email, instant communication and SMS.

5. The remote home security monitoring system according to claim 1, wherein the remote control module further simultaneously transmits the environment audio/video to a remote storage device for storing.

6. A remote home security monitoring method, applied in a cleaning robot, the remote home security monitoring method comprising:
using an air sensor, a temperature sensor and a sound sensor integrated in the cleaning robot to continuously sense a set of ambient data when the cleaning robot is turned on;
analyzing the set of the ambient data based on a set of default security data to generate an ambient state, and determining the ambient state to be dangerous when a difference between the set of the ambient data and the set of the default security data exceeds a tolerable range;
stopping the cleaning robot cleaning when the ambient state is determined to be dangerous, and transmitting a notice message to a user end, and initializing network to provide the user end to link with the cleaning robot; and
providing the user end to remotely control a charge-coupled device and a sound collection element integrated in the cleaning robot to generate and receive environment audio/video after the user end is linked with the cleaning robot.

7. The remote home security monitoring method according to claim 6, wherein the air sensor is configured to sense concentrations of carbon monoxide, fine particulate matter and gas.

8. The remote home security monitoring method according to claim 6, wherein the set of the default security data comprises safe ranges of carbon monoxide, fine particulate matter, gas, ambient temperature and ambient sound.

9. The remote home security monitoring method according to claim 6, wherein the notice message is transmitted to the user end through at least one of email, instant communication and SMS.

10. The remote home security monitoring method according to claim 6, further comprising:
simultaneously transmitting the environment audio/video to a remote storage device for storing.
